(19) United States
(12) Patent Application Publication
(10) Pub. No.: US 2020/0353373 A1
(43) Pub. Date: Nov. 12, 2020

(54) Expanding Character Toy System and Method for Making and Using the Same

(71) Applicants: STEPHEN DONAHUE, MONTREAL (CA); VIC JOSEPH BERTRAND, BEACONSFIELD, QC (CA)

(72) Inventors: STEPHEN DONAHUE, MONTREAL (CA); VIC JOSEPH BERTRAND, BEACONSFIELD, QC (CA)

(21) Appl. No.: 16/866,858

(22) Filed: May 5, 2020

Related U.S. Application Data
(60) Provisional application No. 62/844,096, filed on May 6, 2019.
(60) Provisional application No. 62/898,518, filed on Sep. 10, 2019.

(51) Int. Cl. A63H 3/04; C08G 18/48

(52) U.S. Cl. CPC A63H 3/04; C08G 2101/0008; C08G 18/4866

(57) ABSTRACT

A toy system that includes a memory foam character body. In one version, the memory foam character body is flattened and stored in a fluid tight bag and mechanical restraining sleeve or envelope. In another version, a memory foam body cover and a container that is preferably rigid. The memory foam body is sculpted in the shape of a toy character and is highly compressible from an uncompressed sculpted shape into a compressed shape. A rigid container is provided to contain and maintain the encased sculpted memory foam character body in a compressed state. The rigid container has two or more parts that may be separated from one another to allow the encased sculpted memory foam character body to be compressed into the rigid container. Using these basic elements, the toy platform supports a broad range of selection and innovation in three broad categories: collectible toys; packaging innovation; and differentiated play platform. The basic play method includes the steps of manufacturing a series of sculpted foam-bodied characters that are compressed into the rigid container and the place of manufacture. As packaged, the contents may be concealed from the consumer at the point of purchase. After purchase, the container is opened and the character expands to its full size. The play value is in the initial expansion and in the subsequent “squishability” of the character and in the repeatable action of putting the character back into the container and removing it again. Additional play could come from electronic sound/light features that are triggered by sensors located in various parts of the character body or within the container. These sensors could include those types activated by motion, tilt, bending etc.

This application claims the benefit of the filing date for subject matter described in previous provisional applications 62/844,096 filed May 6, 2019 and 62/898,518 filed Sep. 10, 2019.

### BACKGROUND

### Field of Invention

The invention relates to an expanding character toy system that includes foam-bodied toy characters sold compressed in rigid or other containers that maintain the characters in a compressed state while allowing post sale expansion and methods for manufacturing and using the same.

### Description of Related Art

Expandable foam characters or creatures, sometimes referred to as “grow monsters” have been sold for decades. Known grow monsters are made from superabsorbent polymer materials that can absorb and retain extremely large amounts of a liquid relative to its own mass. The liquid absorbed can be water or an organic liquid. The swelling ratio of a superabsorbent polymer can reach the order of 1000:1. Superabsorbent polymers for water are frequently polyelectrolytes. Known “grow monsters” include encapsulated toys that expand gradually after being immersed in water for several days. The “grow monster” often shrinks in saltwater or simply from air after being removed from water.

While “grow monsters” fill a niche as inexpensive plastic-like toys that get bigger when immersed in water, they aren't well suited for a toy system. Known “grow monsters” have limits in the toy industry. The result, i.e., an expanded character, cannot be sculpted in detail or include artwork. The play value of known grow monsters resides in the fantastic growth not a detailed final character that is barely recognizable as a dinosaur, reptile, insect or other simple character. As such, the play value is almost entirely limited to the fascination in observing the growth. In addition, various brands of expandable water toys have been recalled due to a choking risk. Super absorbent polymer toys are dangerous if swallowed because, as they increase in size, they can get stuck and obstruct a child's intestines.

Another known foam toy evolved from squeezable foam stress balls. These toys are known as “squishies” and made of PU memory foam. Squishies are manufactured into many different shapes and sizes and are often modeled after food or other inanimate objects or animals. Squishies are popular among children and adolescents and are used to relieve stress by squishing the toy, as the name implies. Squishes typically are memory-foam characters of various sizes, with a painted exterior (no fabric covering). The play pattern is just squish and release (similar to a stress ball) and the characters are mostly “cute” representations of animals or emoji's. There have been no versions of this that capitalize on the compression-expansion properties other than just squishing the toy. They are typically sold in plastic bags with a header card.

### SUMMARY

The invention provides a toy system that includes sculpted (preferably covered) foam bodied characters that are compressed and maintained in a compressed state for sale to consumers while allowing post sale expansion. In one embodiment, the characters are compressed into a rigid container such that when the foam bodied character is removed from the rigid container the foam bodied character expands from a compressed form to an expanded form that is significantly larger. In another embodiment, the foam character body is flattened, i.e., compressed primarily in one direction (thickness) with minimal (if any) compression in the other two directions (height and width). The flattened character body is restrained in an airtight bag that has air evacuated to provide a less than atmospheric pressure environment (colloquially referred to as vacuum) so that the bag restrains the flattened character in a flattened state. An additional mechanical restraint my be provided, such as by a sleeve. Embodiments of the foam bodied character, the rigid casing, bag, restraint, sleeve and outer covering are described to provide a new character-based toy platform. Methods of manufacture and use are also described.

Importantly, the character body is under compression whilst in the container and begins to expand immediately as it is removed from the container (whether bag or rigid container). In the rigid container embodiment, this key feature creates a “magic genie” effect whereby the character appears to grow from the container. Also, the consumer product may be sold with the character partially removed from the container such that part of the character is expanded and part is compressed. The amount of compression should be sufficient to allow appreciable expansion, but preferably not so much to preclude recompression into the container. With the preferred materials, a 3:1 expansion ratio for the rigid container embodiment provides a suitable balance and the expansion should be at least 2:1 to achieve sufficiently notable expansion. In an embodiment where the character body is compressed (flattened) primarily in one direction (thickness), the compression in thickness may be as much as 12:1 and minimally 6:1. Naturally, expansion ratios and compression forces depend on the materials used.

The character-based toy platform supports innovation in three broad categories: collectible toys; packaging innovation; and differentiated play platform. As a collectible toy, limitless possible character sculpts and container designs in the character-based toy platform allows for new content interpretation, unique design language, multiple scales and price points and wide demographic appeal with regard to age and gender. Innovation in packaging provides a unique unboxing experience, a surprised reveal, functional play packaging and highly productive retail merchandising. Differentiated play pattern innovation includes characters that can be used in play or display formats or both, a kid powered repeatable action and fun rugged play.

The term foam bodied character includes the range of sculpted toy characters including anthropomorphic characters, cartoon characters, dolls, superheroes, animals, vehicles and the like. The rigid container may be a jar with a removable lid, an egg-shaped container, a character shaped container and the like. Ornamentation may be embossed on the exterior surface of the container.

A toy platform can be provided using a series of sculpted foam-bodied characters that are sold compressed in container. After purchase, the container is opened, and the character expands to its full size. The play value is in the initial expansion, in the subsequent “squishability” of the character and in the repeatable action of putting the character back into the container and removing it again (in the rigid container embodiment). Additional play could come from electronic sound/light features that are triggered by sensors located in various parts of the character body. These sensors could include those types activated by motion, tilt, bending etc.

Types of characters could include representations of popular entertainment or fictional personalities, animals, fantasy creations, inanimate shapes etc.

The character body is made of a type of viscoelastic polyurethane foam AKA low-resilience polyurethane foam (LRPu)—more commonly known as memory foam. The foam body may be covered in a 4-way stretch material that is printed with the appropriate decorations to correctly represent the character. Alternatively, a soft-touch stretch polyester fabric cover may be used. Both cover materials perform well with the compression/expansion play pattern. While the cover is preferred because it helps define the uncompressed appearance of the character body and enables detailed artwork, the cover is not essential. Artwork could be provided directly on the character body. When expanded the character body substantially fills the cover to provide an attractive appearance without excess loose fabric to reveal the character sculpt. In the compressed state the cover is flexible to allow the character body to compress within the cover. When stored within the rigid container the covered character body presses against the interior walls of the container.

The cover material used depends on the character and the desired characteristics, but typically would be a 4-way stretch polyester or soft-touch stretch polyester with either a flat or low-cut plush surface texture. The material does not necessarily need to be stretch but this functionality provides a very tight fit against the foam body which is desirable in order to properly show the character sculpt.

As part of the manufacturing & packaging process, the foam character will undergo compression from a mechanical press, vacuum pump or other device. The character is then sealed in an air-tight container to maintain the compression until opened by the consumer. The dramatic difference between the compressed and decompressed character is a key selling feature of the toy and creates a “surprise” element that is a popular and enduring factor in toy marketing. However, as noted above when it is desired to allow the user to compress the character body into the container, the amount of compression should not be so much as to preclude recompression into the container. The compression needs to be strong enough to squish the character into the container, but not so much that the action cannot be repeated at home by the consumer with just manual strength. To make the toy system “kid-powered and repeatable” the compression of the character into the container can't be a one-time process. In other contexts, where repeated use is not a priority, greater compression can be used.

The container holding the compressed character could take many forms such as an egg, a cube, a tube, a small version of the full-size character etc. The container will have a novel opening feature that will emphasize the “surprise” reveal of the character within. The amount of compression in the container will determine whether the consumer will be able to re-use the container to completely hold the character. If highly compressed, the compression required will not be possible by hand, however the container may be designed in such a way that a portion of the character can be fitted inside. If less compressed, the consumer may be able to reuse the container. To achieve a toy system that is “kid-powered and repeatable,” the consumer must be able to re-use the container and squish the character back into it.

A rigid container offers advantages as to ease of compression and extraction of the expandable character and design features. However, a flexible or semi flexible container could be used within the expanding character toy system. The container need only be able to maintain the character in a compressed state when the character body is within the container. With a flexible or semi-flexible container, the compressed character body within the flexible or semi-flexible container will press the container walls outward until an equilibrium is achieved between the expansion of the compressed character body and the container's resistance to expansion.

The toy may be marketed in packaging that includes the container with the character inside as well as space to describe the features.

Another embodiment of the expanding character toy system uses flat-pack construction in which the character body is compressed/flattened primarily in the thickness direction without significant compression in the height and width dimension. The flat-pack/flattened character body enables variation in the toy platform—a series of sculpted foam-bodied characters that are sold compressed in flat album-like sleeve container that can have printed cover art and can contain additional printed material or other items.

The flat-pack system comprises a memory foam character body, a 4-way stretch fabric covering the memory foam body, airtight flattened packaging and an outer flattened “album cover” type sleeve for the airtight flattened packaging. The outer “album cover” sleeve may be made of paperboard or some other packaging material suitable for printing.

The flat-pack embodiment enables a toy platform with a series of foam-bodied characters that are sold compressed (flattened) in a flat cardboard, paperboard or plastic container. The compression process uses mechanical compression or vacuum compression, a combination of vacuum and mechanical or some other process. The compression results in a significant reduction in one dimension (e.g., thickness/depth) with little or no compression reduction in in the other two dimensions e.g., (length/height, width/breadth). In one example, the overall volume of the character was reduced by a range of 12:1 to 8:1 (median reduction by a factor of 10:1) almost entirely by virtue of a reduction of thickness from 3″ thickness to approximately ¼″ even with some “squish” or flow in the other two dimensions. The compressed body is sealed in a flat airtight container/covering (bag) that substantially maintains the foam body in a compressed state. The flat airtight container has a shape suited to storage in decorative packaging like a vinyl record or CD sleeve. Thus, the thickness dimension is preferably no more than 10% of the length and width dimension. In an example where the outer sleeve resembles a 12″ vinyl LP and the foam character is compressed to ¼″ the ratio of length and width to thickness would be 48:1 with the thickness dimension barely more than 2% of the height and width. The flattened dimensional relationship facilitates shipment and retail display while also providing an appealing packaging play like that of vinyl records and compact discs.

After purchase, the container is opened, and the character expands to its full size. The play value is in the initial expansion and in the subsequent “squishability” of the character, as well as the “collectability” of acquiring multiple characters. A further benefit of this concept is the ability of the decorated packages to be used as room decor items for example wall posters. Additional play could come from electronic sound/light features that are triggered by sensors located in various parts of the character body. These sensors could include those types activated by motion, tilt, bending etc. Types of characters could include representations of popular entertainment or fictional personalities, animals, fantasy creations, vehicles etc.

The product as sold on the shelf could be packaged in a cardboard or plastic sleeve sized to mimic record album sizes i.e. 12″×12″ album, 7″×7″ single or 5″×5″ CD. These sleeves would be fully decorated and could be used as room decor items (wall posters). The flat shape of the sleeve could also accommodate other paper or cardboard inserts that could add to the collectability or decor benefits. The outer sleeve could also be a greeting card that serves as a restraining member to maintain the foam body in a compressed state.

The character body is made of a type of viscoelastic polyurethane foam AKA low-resilience polyurethane foam (LRPu)—more commonly known as memory foam. The foam body is covered in a 4-way stretch material that is printed with the appropriate decorations to correctly represent the character

As part of the manufacturing & packaging process, the foam character will undergo significant compression from a mechanical press, vacuum pump or other device. The character is then sealed in an air-tight flat container to maintain the compression until opened by the consumer. The dramatic difference between the compressed and decompressed character is a key selling feature of the toy and creates a “surprise” element that is a popular and enduring factor in toy marketing.

### BRIEF DESCRIPTION OF DRAWINGS

FIGS. 1A-1C shows three types of encased sculpted memory foam character bodies, namely FIG. 1A a human type doll, FIG. 1B an animal, FIG. 1C a vehicle.

FIG. 2 depicts a human type character compressed into a molded jar and lid container.

FIG. 2A is a free-body diagram showing the relative magnitude and direction of the expansion and reaction forces acting between and inclined wall of the contained and the compressed character body contained within the container.

FIG. 3 depicts a human type character partially removed from the rigid container and partially compressed into the container.

FIG. 4 depicts an animal character compressed into a rigid shell container that has the shape of a bear.

FIG. 5 depicts a character body compressed into an egg-shaped container.

FIG. 6 depicts a machine for compressing a character body into a rigid container.

FIG. 7 depicts a character body being compressed by hand.

FIG. 8 depicts a rectangular box-shaped container with a hinged wall and locking tab.

FIG. 9 depicts a spherical container with a plurality of locking tabs.

FIG. 10 is a perspective view of an alternative character body inspired by a video game.

FIG. 11 is the front view of the alternative character body of FIG. 10.

FIG. 12 is a front before and after perspective view of another embodiment of sculpted memory foam character body.

FIG. 13 is a side before and after view of the sculpted memory foam character body embodiment of FIG. 12.

FIG. 14 depicts the sculpted memory foam character body embodiment of FIG. 12 with the sculpted memory foam character body flattened in one dimension and packaged in a bag on a substrate.

FIG. 15 shows the flattened packaged character body being inserted into a restraining cover, here a sleeve.

FIG. 16 shows the packaged character body partially inserted into and restrained by a restraining cover, a sleeve.

FIG. 17 shows additional packaged or printed material in a sleeve or envelope restraining cover.

FIG. 18A shows an alternative form of translucent container.

FIG. 18B shows an alternative form of container with an ornamental pattern.

FIG. 18C shows an alternative form of container shape.

FIG. 18D shows an alternative form of globe shaped container, with the lid on the bottom.

FIG. 18E shows an alternative form of cube shaped container, with the lid on the bottom.

FIG. 18F shows an alternative form of egg-shaped container, with surface ornamentation and the lid on the bottom.

FIG. 18G shows an alternative form of container, with the lid on the bottom.

FIG. 19A is a front view of an alternative character body in the form of a dinosaur.

FIG. 19B is the rear view of the alternative character body in the form of a dinosaur of FIG. 19A.

FIG. 19C is a perspective view of the alternative character body in the form of a dinosaur of FIG. 19A.

### DETAILED DESCRIPTION OF DRAWINGS

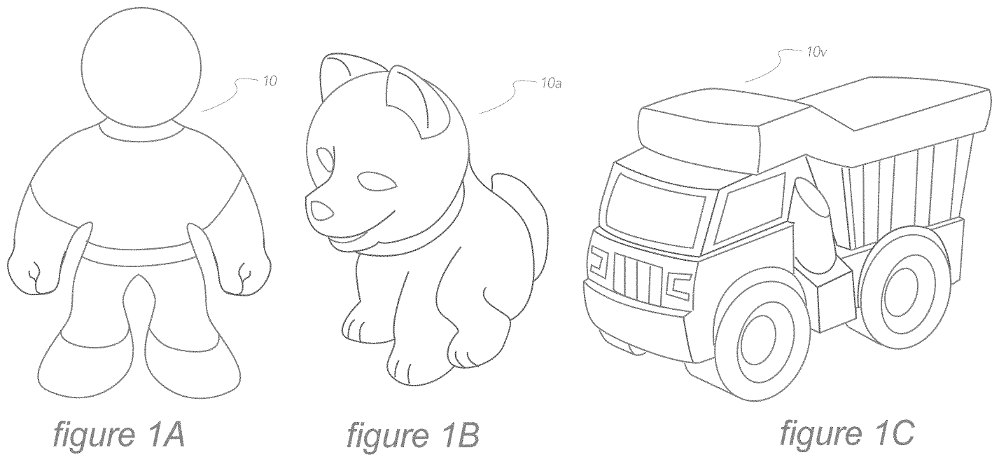

The basic elements of the expanding character toy system are a memory foam character body, a memory foam body cover and a container. In a first embodiment, the container is preferably rigid. The memory foam body is sculpted in the shape of a toy character as shown in FIGS. 1A-1C, for example. The sculpted memory foam character body is highly compressible from an uncompressed sculpted shape into a compressed shape.

A memory foam body cover is preferably provided to encase the sculpted memory foam character body such that when the encased sculpted memory foam character body is in the uncompressed sculpted shape, the memory foam body cover has a tight fit against the sculpted memory foam character body to conform to and reveal the character sculpt.

A rigid container is provided to contain the encased sculpted memory foam character body in a compressed state and maintaining the encased sculpted memory foam character body in a compressed state. The encased sculpted memory foam character body presses against rigid walls of the container. The rigid container has two or more two parts that may be separated from one another to allow the encased sculpted memory foam character body to be compressed into the rigid container. The respective parts of the container include connecting means such as mating threads or interlocking tabs to allow the parts of the container to connect to one another to provide a sealed container for the encased sculpted memory foam character body.

Using these basic elements, the toy platform supports a broad range of innovation in three broad categories: collectible toys; packaging innovation; and differentiated play platform. As a collectible toy, the character-based toy platform allows for new content interpretation, unique design language, multiple scales and price points and wide demographic appeal with regard to age and gender. Innovation in packaging provides a unique unboxing experience, a surprised reveal, functional play packaging and highly productive retail merchandising. Differentiated play pattern innovation includes characters that can be used in play or display formats or both, a kid powered repeatable action and fun rugged play.

The basic play method includes the steps of manufacturing a series of sculpted foam-bodied characters that are compressed into the rigid container and the place of manufacture. As packaged, the contents may be concealed from the consumer at the point of purchase. After purchase, the container is opened and the character expands to its full size. The play value is in the initial expansion and in the subsequent “squishability” of the character and in the repeatable action of putting the character back into the container and removing it again. Additional play could come from electronic sound/light features that are triggered by sensors located in various parts of the character body or within the container. These sensors could include those types activated by motion, tilt, bending etc.

The system can accommodate a wide variety of character types including representations of popular entertainment or fictional personalities, animals, fantasy creations, inanimate shapes etc. FIG. 1 shows three types of encased sculpted memory foam character body, namely: FIG. 1A a human type doll 10; FIG. 1B an animal 10a; FIG. 1C a vehicle 10v.

The character body 10 is preferably made of a type of viscoelastic polyurethane foam AKA low-resilience polyurethane foam (LRPu)—more commonly known as memory foam. The foam used should allow at least 50% percent compression by volume to enhance the initial expansion, an important component of the play value. By compressing the foam body by 50% or more, the expansion will result in at least a doubling of size for play value and also allow post purchase “squishability” of the character body 10. Compressing the foam by 50% corresponds to an expansion ratio of 2:1, which is the minimum to achieve the desired “magic genie” effect whereby the character appears to grow from the container. This “magic genie” is enhanced as the expansion ratio is increased, but greater compression is required. The amount of compression should be sufficient to allow appreciable expansion, but preferably not so much to preclude recompression into the container. Again, “kid powered and repeatable” is also an important feature. With the preferred materials, a 3:1 expansion ratio seems to provide a desirable balance of expansion and force required for recompression. The expansion should be at least 2:1 to achieve sufficiently notable expansion. Naturally, expansion ratios and compression forces depend on the materials used.

The sculpted memory foam character body may have no artwork applied or the sculpted memory foam character body may have artwork applied.

The foam body is covered in a 4-way stretch material that is printed with the appropriate decorations to correctly represent the character. The cover material used depends on the character and the desired characteristics, but typically would be a 4-way stretch polyester with either a flat or low-cut plush surface texture. The material does not necessarily need to be stretched but this functionality provides a very tight fit against the foam body which is desirable in order to properly show the character sculpt. The sculpted memory foam character body may have artwork applied via a tight-fitting cover or directly onto the sculpted memory foam character.

The ability to provide detailed artwork enhances opportunities to obtain character licensing rights and appeal to specific demographic groups. While the cover is preferred because it helps define the uncompressed appearance of the character body and enables detailed artwork, the cover is not essential. Artwork could be provided directly on the sculpted foam body. When expanded the sculpted foam body substantial fills the cover to provide an attractive appearance without excess loose fabric to reveal the character sculpt. In the compressed state the cover is flexible to allow the sculpted foam body to compress within the cover. When stored within the rigid container 20 the covered character body 10 presses against the interior walls of the container.

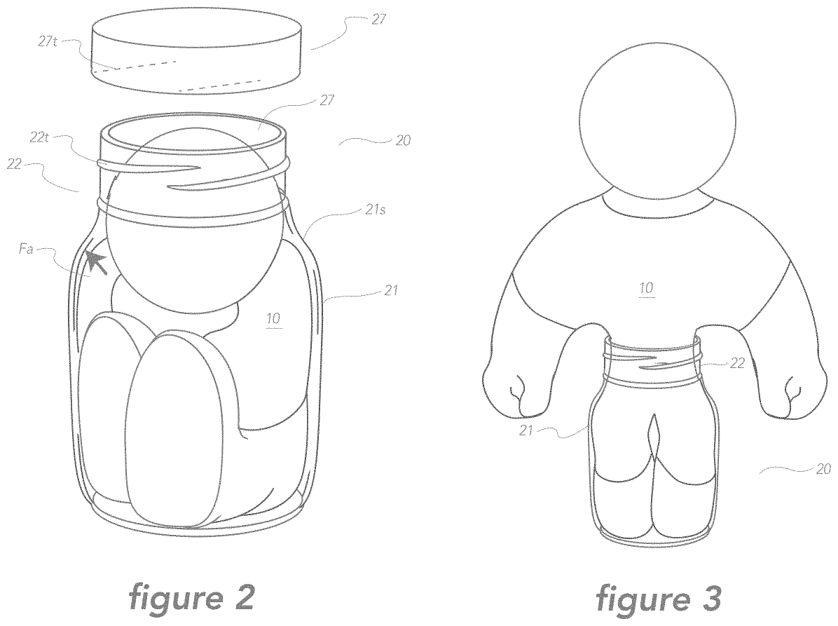

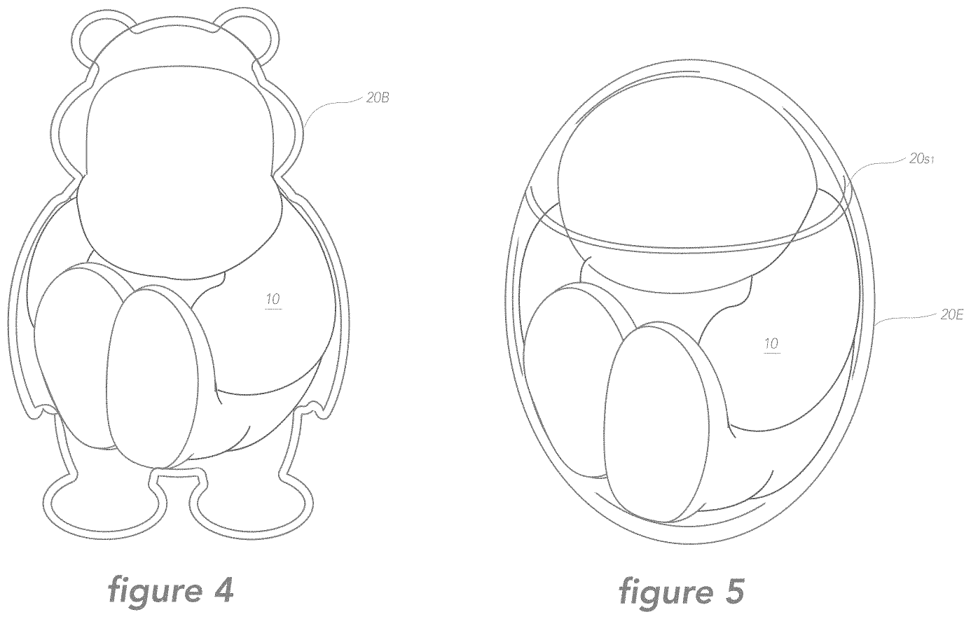

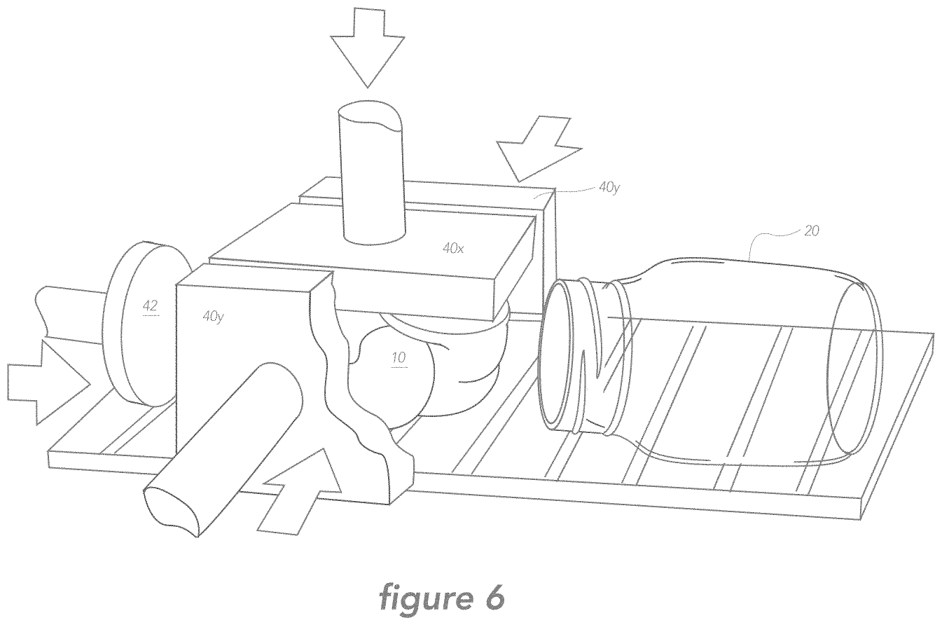

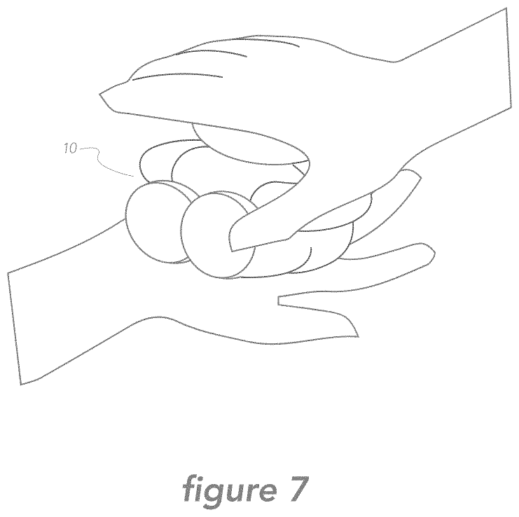

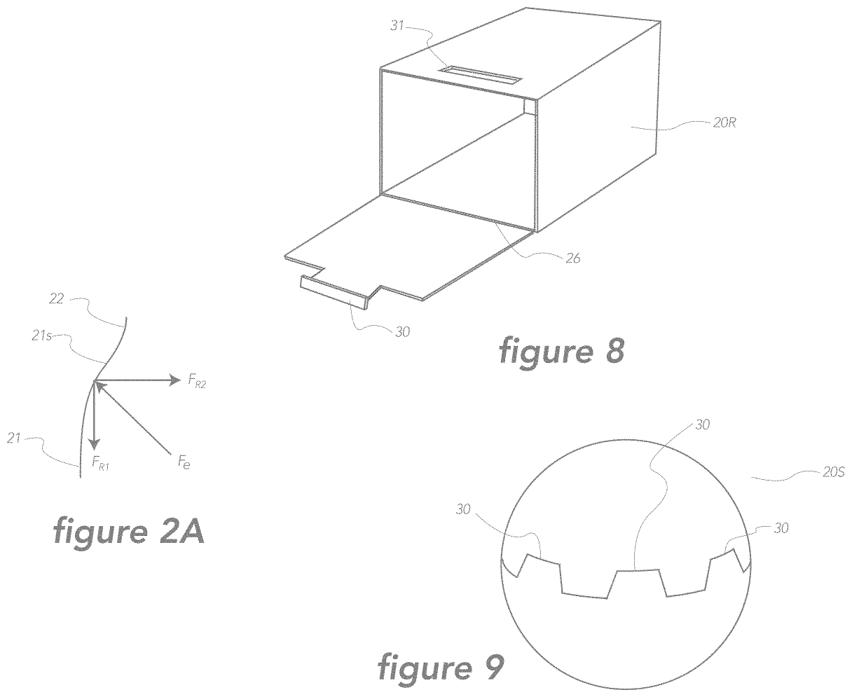

FIG. 2 shows one form of rigid container, a molded open mouth jar 20 that has a jar body 21 a slightly narrowed neck 22 and an open mouth 23. The neck 22 is provided with an external thread 22t. The rigid container also includes a lid 27 provided with an internal thread 27t that mates with the external thread 22t on the neck 22 of the jar 20. A human type character is shown compressed into a molded jar and lid container. A head portion of the character may extend outside the mouth of the jar, but as the lid is screwed onto the jar, the character body 10 is compressed into the jar.

When the lid is removed, the character body expands out of the jar as shown in FIG. 3. A comparison of FIG. 2 and FIG. 3 reveals that the character more than doubles in size as it expands in all three-dimensional directions (thickness/height/width) from the compressed state within the rigid container (here a jar 20). FIG. 3 depicts a human type character 20 partially removed from the rigid container and partially compressed into the container. In some circumstances, it might be desirable to sell the toy in this partially expanded state—in which case, the lid 27 could be omitted, and a one-piece rigid container used.

As shown in FIG. 2 and schematically in FIG. 2A the jar 20 is designed to include a mouth 23 and neck 22 that are slightly less wide than the body 21 of the jar 20. The internal volume is defined by an interior surface of the jar 20 that includes an inclined shoulder 21s that provides some resistance to retraction of the compressed character body 10 since the expansion force F(e) resulting from the body 10 attempting to expand presses against the inner surface of the inclined shoulder 21s resulting in an opposing force pressing the compressed character body 10 inward. The opposing reaction force has a downward component F(R1) pressing the character body downward away from the open mouth and a horizontal component F(R2) pressing the character body laterally inward. The opposing force F(R1) resists retraction of the character body 10 from the container 20, but can be overcome when the consumer pulls the character body 10 outward at which time the inclined surface 21s provides a lever effect to help the compressed body 10 move from the wider jar body 21 through the narrower neck 22 and mouth 23 of the jar 20. FIG. 2A is a free-body diagram showing the relative magnitude and direction of the expansion and reaction forces acting between an inclined wall 21s of the container 20 and the compressed character body 10 contained within the container.

The open mouth jar container is advantageous because it assists a consumer in compressing a character 10 back into the container. However, a wide variety of container shapes may be used to accommodate different needs. Common shapes such as ovoid (egg-shaped), sphere and cube can be used. Alternatively, the container might itself be character shaped to provide a two-character growth play pattern. FIG. 4 depicts an animal character 10 compressed into a rigid shell container 20B that has the shape of a bear. The expanded character is a larger bear so the consumer experiences the growth or transformation of the character.

FIG. 5 depicts a character body 10 compressed into an egg-shaped container 20E. The container has parts releasably connected by a seal connection 20s1. As noted, spherical, cubic or other basic shapes might be desirable. FIG. 8 depicts a rectangular box-shaped container 20R with a hinged wall and locking tab 30. FIG. 9 depicts a spherical container with a plurality of locking tabs 30.

Regardless of the shape of container 20 and character 10, an important step in the manufacturing process is the compression of the character body 10 into the rigid container 20. FIG. 6 depicts a machine for compressing a character body into a rigid container. As shown compression plates 40x, 40y, preferably hydraulic or pneumatic, compress the body 10 along the x and y axes and a circular plate 42 pushes the compressed body into the open-mouthed jar 20. Alternatively, a vacuum pump may be used to evacuate air from the container to create an air pressure less than atmospheric pressure, so air pressure squishes the character body into the container.

FIG. 7 depicts a character body 10 being compressed by hand. Depending on the expansion factor, it may be possible to recompress the character body into the rigid container by hand.

Though a rigid container offers advantages as to ease of compression and extraction of the expandable character and design features, the toy system may further include, a flexible or semi flexible container. The container need only be able to maintain the character in a compressed state when the character body is within the container. With a flexible or semi-flexible container, the compressed character body within the flexible or semi-flexible container will press the container walls outward until an equilibrium is achieved between the expansion of the compressed character body and the container's resistance to expansion.

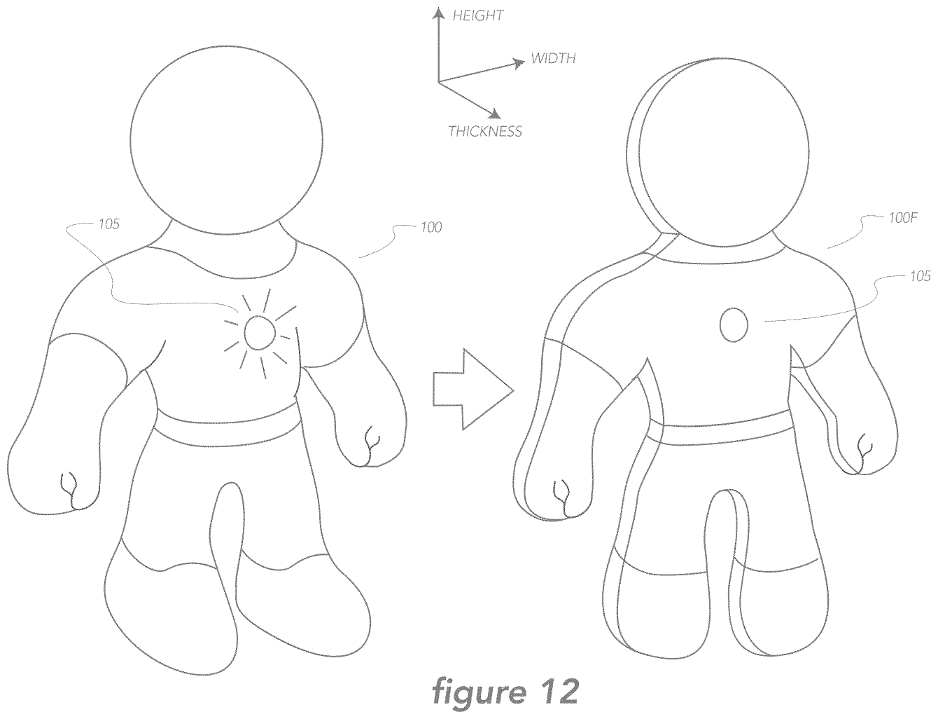

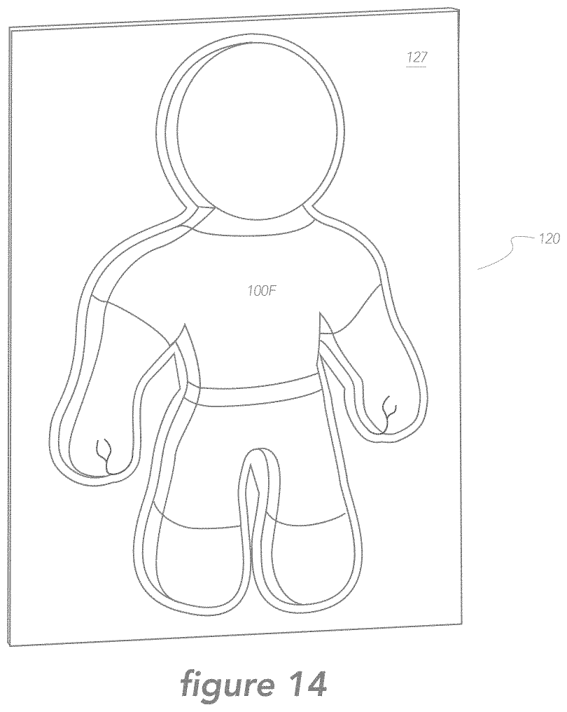

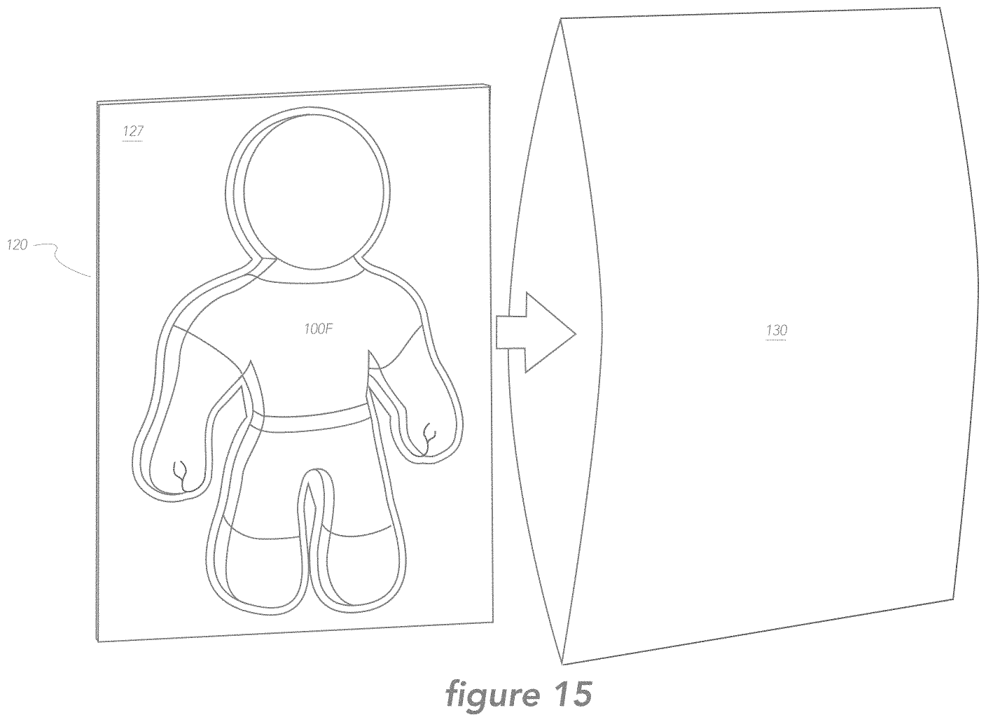

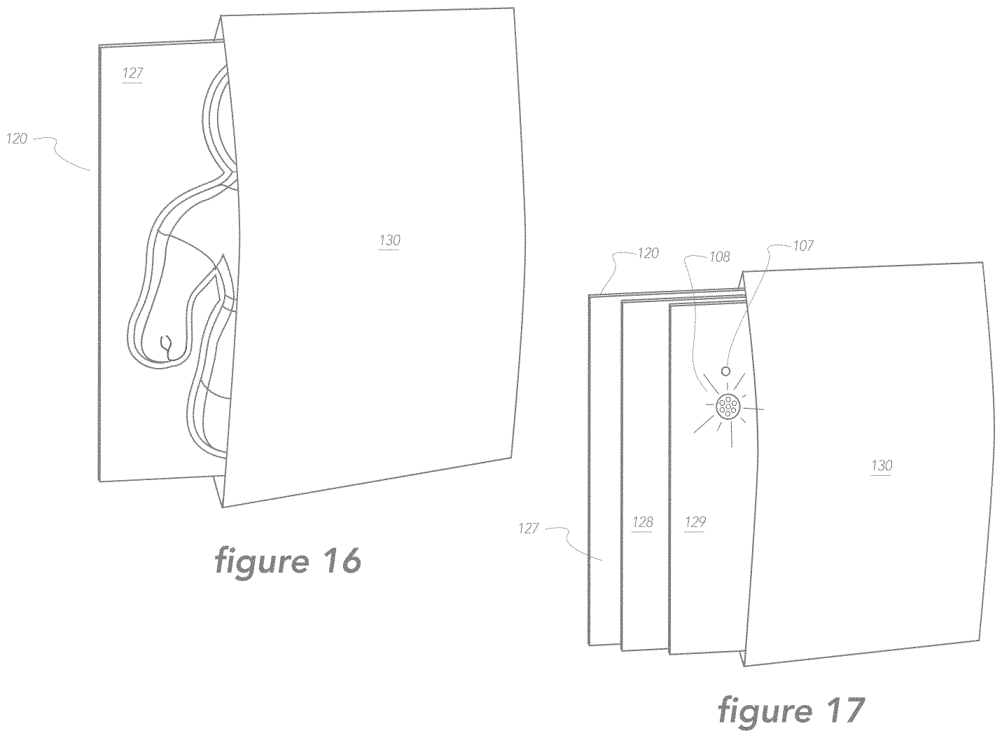

FIGS. 12-17 depict another embodiment of the expanding character toy system that uses a flat-pack construction. This system comprises a sculpted memory foam character body 100, 100F, a 4-way stretch fabric encasing/covering the memory foam body, airtight flattened packaging 120 and an outer flattened “album cover” type sleeve 130 for the airtight flattened packaging. The outer “album cover” sleeve 130 may be made of paperboard or some other packaging material suitable for printing.

In the embodiment of FIGS. 12-17, a memory foam body cover is again preferably provided to encase the sculpted memory foam character body such that when the encased sculpted memory foam character body is in the uncompressed sculpted shape, the memory foam body cover has a tight fit against the sculpted memory foam character body to conform to and reveal the character sculpt. The encased sculpted memory foam character body 100 is packaged by flattening the memory foam character body in one dimension (the thickness dimension indicated in FIG. 12) into a flattened sculpted memory foam character body 100F. This embodiment enables a series of foam-bodied characters 100 that are sold compressed (flattened) in a flat cardboard, paperboard or plastic container 130. The compression process uses mechanical compression or vacuum compression, a combination of vacuum and mechanical or some other process.

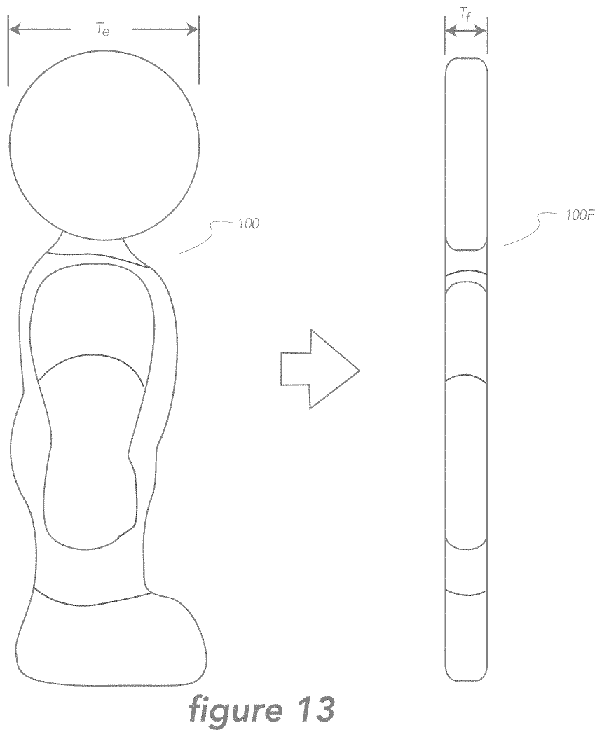

FIGS. 12 and 13 show before and after views from front and side showing the character body compressed to about ¼″ thick and fully expanded to about 3″ thick. As shown in FIG. 13, the compression results in flattening—a significant reduction in one dimension (e.g., thickness/depth) with little or no compression reduction in in the other two dimensions e.g., (length/height, width/breadth). In one example, the overall volume of the character was reduced by a range of 12:1 to 8:1 (median reduction by a factor of 10:1) almost entirely by virtue of a reduction of expanded thickness Te from 3″ thickness to flattened thickness Tf of approximately ¼″ even with some “squish” or flow in the other two dimensions.

As shown in FIG. 14, the compressed body 100F is sealed in a flat airtight container/covering (bag) 120 that substantially maintains the foam body in a compressed state. A flat substrate 127 of cardboard, paperboard or plastic may be provided to support the flattened body within the bag 130 and keep the flattened body from, for example, folding.

As shown in FIGS. 15-17, the flat airtight container 120 has a shape suited to storage in decorative packaging like a vinyl record or CD sleeve 130. Thus, when flattened, the thickness dimension Tf of the flattened character body 100F is preferably no more than 10% of the length and width dimension of the sleeve 130. In an example where the outer sleeve resembles a 12″ vinyl LP and the foam character is compressed to ¼″ the ratio of length and width to thickness would be 48:1 with the thickness dimension barely more than 2% of the height and width of the sleeve 130. The flattened dimensional relationship facilitates shipment and retail display while also providing an appealing packaging play like that of vinyl records and compact discs.

After purchase, the container is opened, and the character 100F expands to its full size 100. The play value of this embodiment of toy system is in the initial expansion and in the subsequent “squishability” of the character, as well as the “collectability” of acquiring multiple characters and decorative containers or sleeves. A further benefit of this concept is the ability of to use decorated packages as sleeves 130 for room decor items such as wall posters. Additional play could come from electronic sound/light features that are triggered by sensors located in various parts of the character body or packaging. These sensors could include those types activated by motion, tilt, bending etc. One example is shown in FIG. 12 where the character body has a led light element 105. In the expanded form 100, the light is ON, but when pressed inward as in the flattened form 100f the light 105 is off. Another example is shown in FIG. 17, where a spring-loaded switch 107 springs open when an insert 129 is removed from the sleeve. The changed state of the switch 107 activates a sound generating device 108 as shown. Types of characters could include representations of popular entertainment or fictional personalities, animals, fantasy creations, vehicles etc.

The product as sold on the shelf could be packaged in a sleeve 130 made of cardboard or plastic and sized to mimic record album sizes i.e. 12″×12″ album, 7″×7″ single or 5″×5″ CD. These sleeves 130 would be fully decorated and could be used as room decor items (wall posters). The flat shape of the sleeve could also accommodate other paper or cardboard inserts 128, 129 that could add to the collectability or decor benefits. The outer sleeve 130 could also be a greeting card or envelope that serves as a restraining member 130 to maintain the foam body in a compressed state.

The character body 100 is made of a type of viscoelastic polyurethane foam AKA low-resilience polyurethane foam (LRPu)—more commonly known as memory foam. The foam body 100 is covered in a 4-way stretch material that is printed with the appropriate decorations to correctly represent the character

As part of the manufacturing & packaging process, the foam character will undergo significant compression from a mechanical press, vacuum pump or other device. The character is then sealed in an air-tight flat container to maintain the compression until opened by the consumer. The dramatic difference between the compressed and decompressed character is a key selling feature of the toy and creates a “surprise” element that is a popular and enduring factor in toy marketing.

The flattened container may be an airtight container bag 120 composed of a PA/PE (Polyacrylate/Polyethylene) structure where PA is for puncture resistance and PE is for sealing. If an enhanced barrier is desired more layers or substrates may be used to provided different structures such as a high barrier PA/EVOH/PE structure. Materials used in high barrier structures include Polyvinylidene chloride (PVDC) and ethylene vinyl alcohol (EVOH). Shelf life indication can be effectively measured by how many cubic centimeters of oxygen can permeate through 1 square meter of material over a 24-hour period. A standard PA/PE bag allows on average 100 cubic centimeters, PVDC allows on average over 10, and EVOH on average 1 cubic centimeter. Multi-layer structures allow the ability to use strong oxygen-barrier materials for enhanced shelf life protection. Factors to consider in selecting appropriate airtight packaging include cost and resistance to expansion.

The airtight container storage bag 120 is constructed such that the bag retains the desired flattened form 100F suitable for packing within a packaging sleeve 130. The bag has structure that allows evacuation of air and sealing of the foam body in the airtight bag. For example, the bag may be provided with a non-return (one way) valve or sealable suction port preferably made of a synthetic resin material on one portion thereof optionally, a base member or substrate 127 having a planar form may be put inside the compression storage bag to retain the shape of the base portion of the compression storage hag. To evacuate air from the foam body and compress/further con/press the body, suction is applied, e.g., through a vacuum suction nozzle inserted into a sealable suction port or opening portion of the non-return valve in this state. The vacuum pump may be any type of pump, e.g., centrifugal or reciprocating, which can create enough pressure differential between the inside and outside of the airtight container bag to compress the foam body. The compression storage bag 120 and foam body 100 are compressed to define a substantially rectangular shape. Other methods of evacuating air to compress and seal the foam body in an airtight package may be used. The choice of technology depends on cost and volume required.

The general technique employed is encasing the foam body 100 in a flattened airtight container 120—the foam body may be partially mechanically compressed before being interested into the container or compressed only after being inserted into the container. Within the container the foam body may be compressed mechanically, by evacuation or air or a combination of both mechanical compression and evacuation of air.

The foam body 100 is then enclosed within a container 120 which is substantially fluid (gas or liquid) impervious and capable of undergoing a reduction in volume, fluid (typically air) is evacuated from the container to reduce it in volume under the influence of atmospheric pressure to thereby compress the cellular material, and a mechanical restraining member is then placed around the container and its contents. The mechanical restraining member may be the bag 120 itself, which has some resistance to expansion and is able to preserve a reduced air pressure within the bag. Alternatively, some supplemental restraint 130 may be provided. The supplemental restraint could be a separate wrapping or provided by the outer packing sleeve 130 of cardboard, paperboard or plastic. The outer packaging also provided additional puncture resistance to preserve the integrity of the airtight enclosure.

In this embodiment, the flattened foam body 100f is compressed in thickness if but retains width dimensions substantially equal to its original width dimensions at atmospheric pressure. The length/height dimension remains about the same and could become wrinkled to provide some axial rigidity. The resulting package includes the compressed foam foam body 100E encased within a substantially fluid impervious container 120 having an internal pressure of less than atmospheric pressure and a restraining member such as a paperboard/cardboard sleeve or envelope to help hold the package to its compressed dimensions. The degree of restraint or resistance to expansion of the restraining member depends on the thickness and structure of the restraining member 130. The restraining member may provide just nominal resistance, or the restraining member may maintain compression even if the pressure within the container were restored to atmospheric. In the latter example, removing the flattened container 120 from a restraining sleeve 130 would trigger expansion of the foam body 100. Additional structure may be provided to puncture or otherwise break the airtight seal of the flattened container when the container is removed from the sleeve or envelope.

To avoid premature expansion of the compressed foam body, a restraining member 130 sufficiently strong to hold the foam body material in its compressed state after fluid (air) has been readmitted to the package may be placed around the compressed package. The restraining member employed may be a sleeve 130 of similar but slightly larger size than the compressed material and thus hold the container at substantially its compressed volume. In such a case, it is preferable that the sleeve 130 of cardboard, paperboard, plastic or other suitable material be provided around the compressed foam body. Alternatively, the restraining member may be of a greater size than the compressed foam body, thus permitting the foam to expand against and assume the shape and size of the mechanical restraint. In such an embodiment a sleeve of some suitable material may simply be drawn over the evacuated assembly which is then permitted to reexpand. The resulting package may thus be retained in its evacuated state for a prolonged period of time, for example while it is being stored or transported, although it is preferable that fluid (here, air) be admitted into the container until the pressure is again substantially atmospheric. In such a case, the restraining member will prevent substantial expansion of the compressed material or a change in its shape.

This flattened body 100F embodiment may be advantageous in that, the foam body is compressed only through the thickness dimension, rather than through all its dimensions as in the case of the previous embodiment. This one-dimensional compression limits distortion of the foam body in the other two dimensions so that the appearance of the foam body is more appealing as it rexpands. The outer covering of the foam character body is designed so that is not wrinkled or damaged by packing in this manner. The reexpansion of the foam stretches the fabric to eliminate any wrinkles from packaging. Even so, limiting compression in two dimensions and compressing almost entirely in the thickness direction helps ensure that the sculpted character body rexpands as desired.

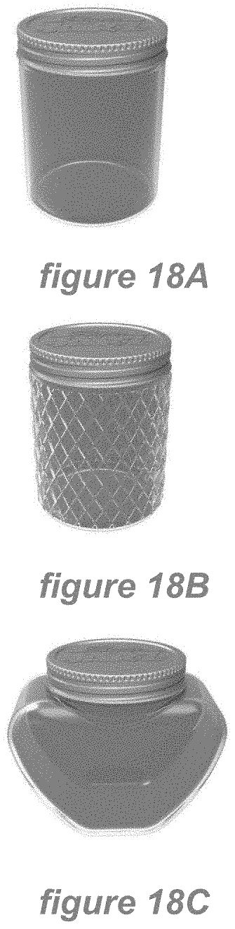

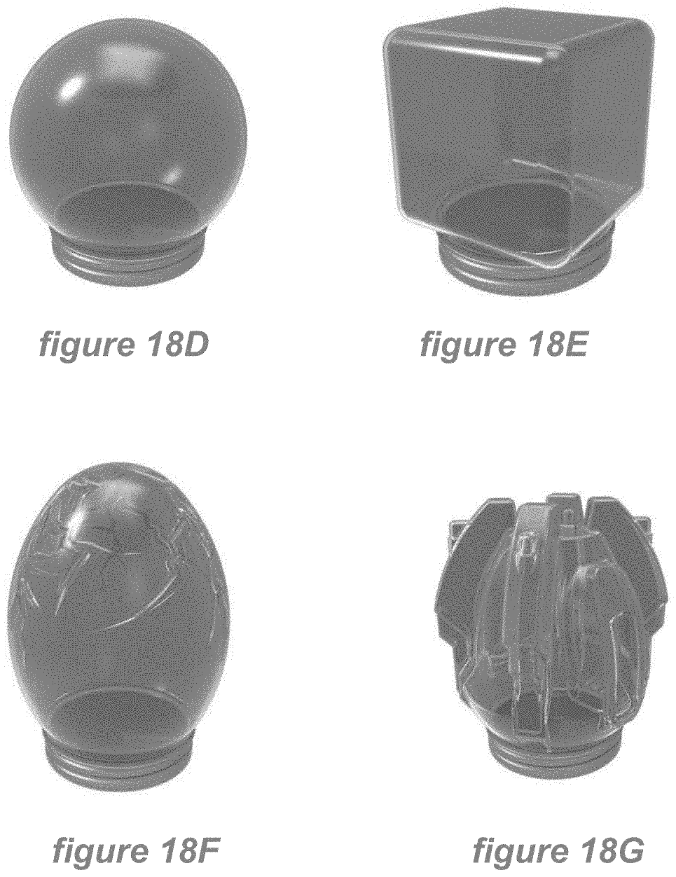

A wide variety of alternative container configurations and colors are possible. FIGS. 18A-G show illustrative examples. FIG. 18A shows an alternative form of translucent container with a lid that may be in a variety of colors and include ornamentation. FIG. 18B shows an alternative form of container with an ornamental pattern embossed on the surface. FIG. 18C shows an alternative form of truncated triangular container shape. FIG. 18D shows an alternative form of globe shaped container, with the lid on the bottom. FIG. 18E shows an alternative form of cube shaped container, with the lid on the bottom. FIG. 18F shows an alternative form of egg-shaped container, with surface ornamentation embossed on the container body and the lid on the bottom. FIG. 18G shows an elaborate alternative form of container, with the lid on the bottom.

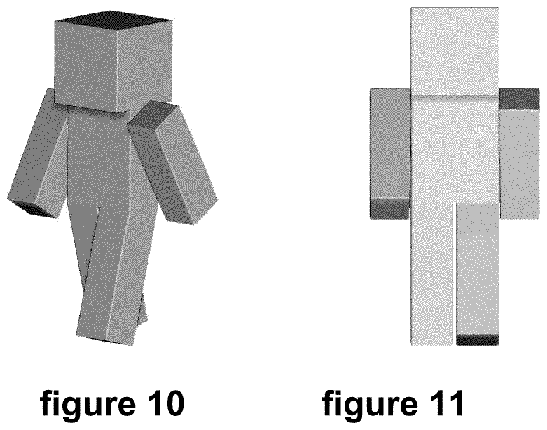

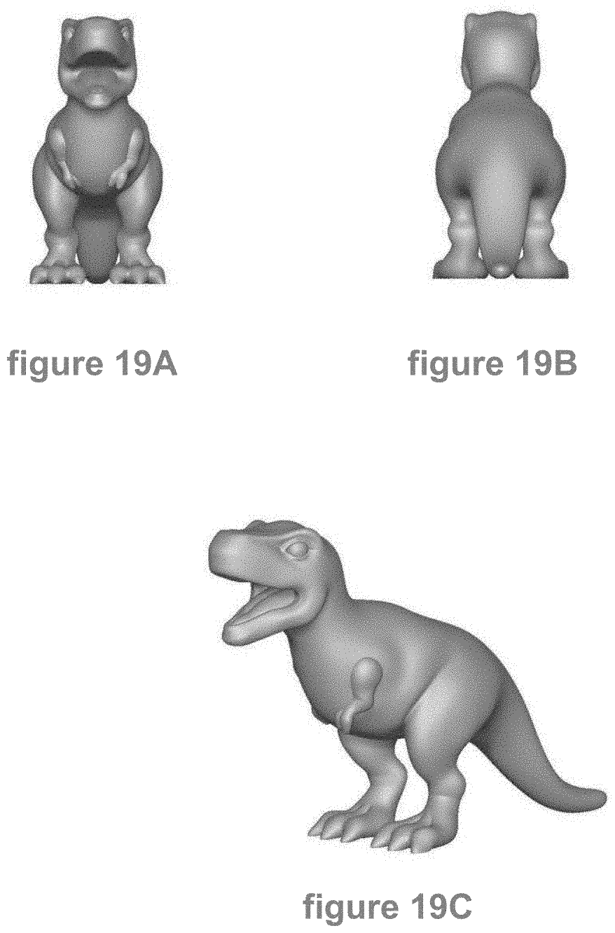

Other character bodies are shown in FIGS. 19A-C, 10 AND 11. FIGS. 19A-C show an alternative character body in the form of a dinosaur. FIGS. 10-11 show an alternative character body inspired by a video game.

As illustrated and described herein, the toy system has a wide variety of adaptations. The character bodies themselves can mimic licensed known characters in every scale with varying levels of accuracy. The system is compatible and can work within a larger construction or other toy eco-system such as LEGO®, MEGA®, PLAYMOBIL® as examples. The packaging may be provided with structural features (e.g., an array of cylindrical studs or other connectors) to facilitate use within an existing toy ecosystem. The character bodies may be adapted to different target audiences such as Japanese chibi style characters or softened, younger looking, characters.

The character bodies are custom created memory foam designed for maximum compression and expansion. One possible cover material is a 4-way stretch knit polyester and another is a soft-touch stretch poly. Both cover materials perform well with the compression/expansion play pattern. Exemplary characters depicted are a basic form, but character specific attributes may be added to reveal ‘magic” such as, capes, weapons, gear etc.

The toy system play pattern is a kid powered, repeatable action feature, in the jar/out of the jar. It's rugged play and collectible. The containers shown can be universally recognized by young and old, surprising/fun, see-through, customizable. The packaging provides innovation in a unique unboxing experience, a surprise reveal and functional play packaging.

The character types include “heroes and villains”—characters from cinematics universes, comics, television; “Wild Word”—animals including wildlife (Gorillas, sharks, lions, puppies, kittens) and dinosaurs or mythical animals and “Wheels and Wings”—vehicles. The character bodies may feature exaggerated proportions, fun accents, multiple poses & character specific elements and assorted materials to add diversity & collectability

We claim:

1) An expanding character toy system comprising:
a memory foam body that is sculpted in the shape of a toy character, the sculpted memory foam character body being compressible from an uncompressed sculpted shape into a compressed shape;
a memory foam body cover encasing the sculpted memory foam character body such that when the encased sculpted memory foam character body is in the uncompressed sculpted shape, the memory foam body cover has a tight fit against the sculpted memory foam character body to conform to and reveal the character sculpt;
a rigid container for containing the encased sculpted memory foam character body in a compressed state and maintaining the encased sculpted memory foam character body in a compressed state wherein the encased sculpted memory foam character body presses against rigid walls of the container, the rigid container having at least two parts that may be separated from one another to allow the encased sculpted memory foam character body to be compressed into the rigid container and the parts of the container including connecting means to allow the parts of the container to connect to one another to provide a sealed container for the encased sculpted memory foam character body.

2) The expanding character toy system of claim 1, wherein the rigid container is a molded jar and a lid, the molded jar including an open mouth with a screw thread provided on the outer perimeter of the mouth, the lid including a rim having an internal thread for engaging the screw thread of the jar such that the lid can be screwed onto the mouth of the jar to seal the jar while providing a compressive force toward any portion of the encased sculpted memory foam character body pressing against the lid, whereby the thread on the jar and the thread on the lid provide the connecting means to allow the parts of the container to connect to one another to provide a sealed container for the encased sculpted memory foam character body.

3) The expanding character toy system of claim 1, wherein the rigid container is a hollow shell containing at least two distinct parts that include connecting means to allow the parts of the shell to releasably connect to one another to provide a sealed container for the encased sculpted memory foam character body.

4) The expanding character toy system of claim 3, wherein the hollow shell has an egg shape.

5) The expanding character toy system of claim 3, wherein the hollow shell has a sculpted character shape that is smaller in volume than the expanded volume of the expanded volume of the encased sculpted memory foam character body that it contains, but larger in volume than the encased sculpted memory foam character body in a compressed state.

6) The expanding character toy system of claim 3, wherein the connecting means comprises at least one locking tab provided on one of the distinct parts of the hollow shell, the locking tab being releasably engageable with another distinct part of the hollow shell to releasably lock the hollow shell parts to one another.

7) The expanding character toy system of claim 3, wherein the connecting means comprises interlocking threads provided on the parts of the hollow shell.

8) An expanding character toy system comprising:
a memory foam body that is sculpted in the shape of a toy character, the sculpted memory foam character body being compressible from an uncompressed sculpted shape into a compressed shape;
a memory foam body cover encasing the sculpted memory foam character body such that when the encased sculpted memory foam character body is in the uncompressed sculpted shape, the memory foam body cover has a tight fit against the sculpted memory foam character body to conform to and reveal the character sculpt;
a flattened substantially fluid impervious container bag for containing the encased sculpted memory foam character body in a compressed state wherein the foam character body is compressed under the influence of atmospheric pressure; and
a mechanical restraining cover surrounding the flattened container and its contents, at least one of the container bag and the mechanical restraint maintaining the encased sculpted memory foam character body in a compressed state.

9) A method of packaging a memory foam body that is sculpted in the shape of a toy character, wherein the memory foam body is encased in a stretch fabric cover such that when the encased sculpted memory foam character body is in the uncompressed sculpted shape, the stretch fabric cover has a tight fit against the sculpted memory foam character body to conform to and reveal the character sculpt; the method comprising compressing the steps of:
placing the encased sculpted memory foam character body into a flexible, substantially fluid impervious container, compressing the stretch fabric encased sculpted memory foam character body in one dimension with no more than limited compression of the stretch fabric encased sculpted memory foam character body in the other two dimensions, evacuating fluid from the container to reduce it in volume and compress the foam body into a flattened shape, and enclosing the compressed container within a mechanical restraining member.

10) The method of packaging a memory foam body that is sculpted in the shape of a toy character of claim 9, wherein the mechanical restraining member is a sleeve made of cardboard.

11) The method of packaging a memory foam body that is sculpted in the shape of a toy character of claim 9, wherein the mechanical restraining member is a sleeve made of paper board.

12) The method of packaging a memory foam body that is sculpted in the shape of a toy character of claim 9, wherein the mechanical restraining member is a sleeve made of plastic.

13) The method of packaging a memory foam body that is sculpted in the shape of a toy character of claim 9, wherein the mechanical restraining member is an envelope and card.
